(19) United States
(12) Patent Application Publication
(10) Pub. No.: US 2009/0304574 A1
(43) Pub. Date: Dec. 10, 2009

(54) Configurations And Methods Of Hydrogen Fueling

(75) Inventor: Ravi Ravikumar, Lancaster, CA (US)

Correspondence Address: FISH & ASSOCIATES, PC;ROBERT D. FISH, 2603 Main Street, Suite 1000, Irvine, CA, 92614-6232, US

(73) Assignee: FLUOR TECHNOLOGIES CORPORATION, Aliso Viejo, CA (US)

(21) Appl. No.: 12/300,364

(22) PCT Filed: Jun. 26, 2007
(86) PCT No.: PCT/US07/14875

§ 371 Date: Feb. 10, 2009

Related U.S. Application Data
(60) Provisional application No. 60/817,168, filed on Jun. 27, 2006.

(51) Int. Cl. C01B 3/04; B01J 10/00

(52) U.S. Cl. 423/658.2; 422/187

(57) ABSTRACT

Configurations and methods are contemplated in which an automobile filing station receives liquid ammonia and in which hydrogen is produced by catalytic cracking. The so produced hydrogen is then compressed and fed to a filling dock. Preferably, contemplated stations will include a polishing unit in which undissociated ammonia is removed and fed back to the ammonia storage tank.

This application claims priority to our U.S. provisional patent application with Ser. No. 60/817,168, filed Jun. 27, 2006, which is incorporated by reference herein.

### FIELD OF THE INVENTION

The field of the invention is fueling stations for hydrogen-fueled automobiles.

### BACKGROUND OF THE INVENTION

Hydrogen fuel has become an increasingly attractive alternative to fossil fuels due to the relatively high energy density and environmentally friendly oxidation products. Further, hydrogen can be produced from numerous sources in an at least conceptually simple manner. Among various other production methods, hydrogen can be generated from ammonia using catalytic cracking to nitrogen and hydrogen according to Equation I below:

2NH₃->N₂+3H₂ Equation I

Exemplary catalytic cracking processes are well known and described, for example, in U.S. Pat. No. 6,936,363, or in the “Hydrogen, Fuel Cells, and Infrastructure Technologies Progress Report” of 2003 by Faleschini et al. Remarkably, in these and other known papers, ammonia cracking is either performed on-board a vehicle in a small-scale reactor that is coupled to a hydrogen combustion device (e.g., fuel cell or burner) to power an automobile, or in large-scale reactors to produce large quantities hydrogen that is then distributed to filling stations as compressed or liquefied fuel. While such methods and processes provide certain advantages, numerous difficulties, especially in view of automotive fueling remain.

For example, where large-scale ammonia cracking is performed to produce hydrogen in mass quantities for delivery to hydrogen fueling stations, many safety issues related to transport of large quantities of hydrogen are still unresolved. Moreover, hydrogen losses from tanks holding compressed or liquefied hydrogen are relatively high. Such losses can be almost entirely avoided where hydrogen is produced from ammonia directly at the site of combustion or use in a fuel cell. However, the size and the cost of currently known typical ammonia crackers to power an automobile engine is typically prohibitive. Alternatively, one or more smaller ammonia crackers may employed, however, such devices will typically only supplement the energy requirements of the automobile and therefore require a second source of energy.

Therefore, while numerous configurations and methods of producing hydrogen from ammonia are known in the art, all or almost all of them suffer from various disadvantages. Consequently, there is still a need to provide improved configurations and methods for hydrogen production from ammonia, especially where hydrogen is used to fuel an automobile or other vehicle.

### SUMMARY OF THE INVENTION

The present invention is directed to configurations and methods of hydrogen fueling for automobiles in which a hydrogen fueling station has a storage tank for liquefied ammonia, and in which an ammonia cracker produces hydrogen that is compressed and/or liquefied for feeding a fueling dock.

In an especially preferred aspect of the inventive subject matter, hydrogen is provided to an automobile at a fueling station in a method in which liquefied ammonia is received from a remote ammonia source and stored at an automobile fueling station. A portion of the stored ammonia is then converted to hydrogen at the fueling station, and where desired or needed, undissociated ammonia is removed from the hydrogen, which is then delivered as fuel to the automobile. Most typically, the ammonia is cracked in a preferably autothermal catalytic process using a catalyst (e.g., comprising nickel, ruthenium, and/or platinum). In still further contemplated aspects, undissociated ammonia is removed in a cryogenic, an adsorptive process, and/or a membrane separation, and preferably recycled to the ammonia storage tank where the liquefied ammonia is preferably stored at a pressure of at least 20 atm and/or a temperature of less than −35° C.

Depending on the sales volume and frequency of fueling events, conversion of the ammonia to hydrogen may be performed in several on-demand cycles or in a continuous mode. Regardless of the manner of hydrogen production, it is contemplated that hydrogen is compressed to at least fueling pressure, and that where suitable, the hydrogen is also stored at a pressure of at least fueling pressure. Preferably, the stored hydrogen has a volume of less than 100%, more preferably less than 50%, and most preferably less than 20% of an average daily dispensed hydrogen volume.

With respect to the remote ammonia source it is contemplated that all ammonia plants are deemed suitable, however, especially preferred plants include gasification plants that may or may not co-produce carbon dioxide for sequestration, enhanced oil recovery, or for sale as a byproduct.

Therefore, in another aspect of the inventive subject matter, contemplated automobile fueling stations will have an ammonia storage tank that configured to store liquid ammonia, and an ammonia cracking reactor that is fluidly coupled to the storage tank and configured to produce hydrogen from the ammonia. Most preferably, a polishing unit is fluidly coupled to the reactor and configured to remove undissociated ammonia, and a hydrogen storage tank and a compressor are fluidly coupled to the polishing unit and configured to provide compressed hydrogen to a filling dock for fueling compressed hydrogen to an automobile. Most preferably, the polishing unit comprises a cryogenic, adsorptive unit, and/or membrane unit, to which a recycling conduit is coupled that feeds the undissociated ammonia back to the ammonia storage tank. Further preferred stations include a catalytic autothermal reactor that is configured for continuous operation.

Various objects, features, aspects and advantages of the present invention will become more apparent from the following detailed description of preferred embodiments of the invention and the accompanying drawing.

### BRIEF DESCRIPTION OF THE DRAWING

FIG. 1 is an exemplary representation of an ammonia/hydrogen generation and distribution system

### DETAILED DESCRIPTION

The inventor has discovered that various advantages of hydrogen fueling of a vehicle and condensed energy transport of hydrogen via ammonia shipping and decentralized cracking can be combined in a system where ammonia is transported to fueling stations using an already well established ammonia transport infrastructure, and where the fueling stations include a mid-sized modular reactor in which ammonia is cracked to hydrogen in an amount sufficient to supply current demand (e.g., of an average 24 hour period, or even less). Thus, losses associated with transport and storage of relatively large quantities of hydrogen are avoided.

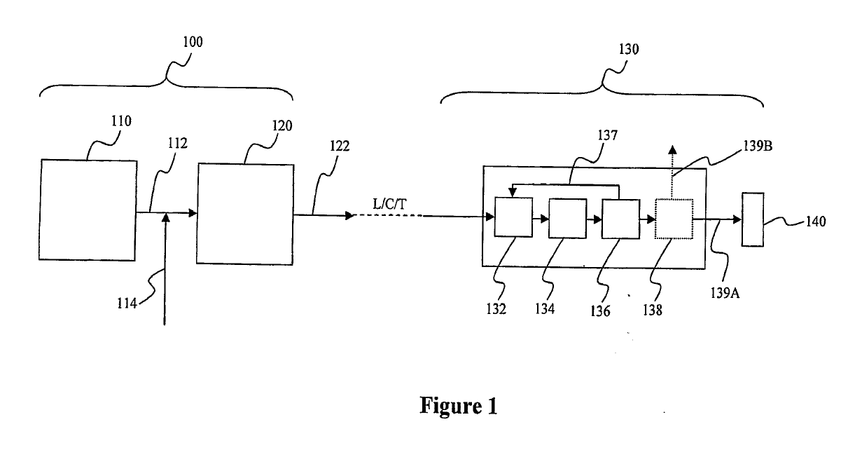

An exemplary ammonia/hydrogen generation and distribution system is depicted in the schematic of FIG. 1 in which an ammonia production plant 100 and a fuel station 130 are shown, and in which liquefaction, compression, and transport are represented by a dashed line. The ammonia production plant 100 preferably includes a coal gasification unit 110 that generates syngas 112. The hydrogen to nitrogen ratio is adjusted, typically by addition of nitrogen 114 using conventional technology to form a raw gas that is then fed to the catalytic reactor(s) 120 to form ammonia stream 122.

Ammonia stream 122 is then liquefied and transported (e.g., via tankers or pipeline) to the storage tank 132 of fueling station 130, and from there (on demand or in a continuous manner) fed to the catalytic reactor 134 where the ammonia is catalytically dissociated to nitrogen and hydrogen. Residual undissociated ammonia is removed from the hydrogen and nitrogen in polishing unit 136 and fed back to the storage tank 132 via recycle conduit 137. The so produced hydrogen/nitrogen stream can then be processed in an optional separation unit 138 (e.g., using a hydrogen selective membrane) in a hydrogen enriched stream 139A and a nitrogen enriched stream 139B that can be safely vented to the atmosphere. The hydrogen enriched stream 139A is then fed to the fueling dock 140 for use as vehicle fuel in an automobile (not shown).

With respect to the ammonia production plant, it should be recognized that all known plant configurations are deemed suitable for use herein, and that the specific manner will predominantly depend on the availability of certain feedstocks and/or geographic location of the production plant. However, it is preferred that the ammonia production is a large-scale facility, typically coupled with a gasification plant (e.g., via steam reforming of natural gas or other light hydrocarbons [NGL, LPG, Naphtha, etc.], or via partial oxidation of heavy fuel oil or vacuum residue). For example, coal or petroleum coke can be gasified using oxygen in a high temperature entrained bed gasifier to thereby produce raw syngas, which can be cooled to recover energy as steam. The so formed raw syngas is then shifted to convert most of the CO to H₂, cleaned to remove sulfur and other impurities, and processed (e.g., in a pressure swing adsorption unit) to separate pure H₂, which can then be blended with N₂ (e.g., from an air separation unit) to achieve a proper stoichiometric ratio of H₂ to N₂. Ammonia is then produced from the processed syngas while CO₂ is recovered as byproduct for sale as food grade CO₂, for sequestration, or enhanced oil recovery. Therefore, it should be appreciated that ammonia can be produced with minor greenhouse gas emissions. Among various other advantages, it is noted that large coal, petroleum coke, and biomass gasifiers are well established and can produce ammonia in a cost-effective way in commercially proven plants. Depending on the type of production facility and other factors, the ammonia may be further purified or otherwise processed (e.g., removal of inert gases, water, etc.), and most typically, the ammonia is condensed and pressurized to suitable storage and/or transport conditions (e.g., pressure between about 15-50 bar, and temperatures between −30 to −50° C.). Therefore, suitable ammonia will typically have a purity between 90-95 mol %, more typically between 95-98 mol %, and most typically higher than 98 mol %. Residual impurities will preferably be oxygen and water. Moreover, it should be noted that suitable networks to store and distribute liquid ammonia already exist as ammonia is currently the chemical compound with the largest production volume. Still further, it should be appreciated that liquid ammonia contains about 1.7 times more H₂ than liquid H₂ for a given volume. Thus, ammonia offers a significant advantage in cost and convenience over pure hydrogen for transport and storage purposes.

Viewed from an economic perspective, it should be recognized that gasification of abundantly available coal to produce ammonia in a cost effective way and using the ammonia to supply the H2 required for a highly efficient fuel cell for vehicle operation contributes significantly to the national energy security. Moreover, the overall thermal efficiency of converting coal to energy required by the fuel cell based vehicle is higher than that of the liquid transport fuel to power the vehicle. Heretofore, coal gasification plants loads were typically variable as the use of ammonia for the fertilizer industry is cyclical in nature. Using ammonia in the transportation industry will now allow operation of coal gasification plants on a base load mode selling ammonia to both the fertilizer industry and for H₂ production for vehicle operation in varying quantities to maximize overall product revenue. In further alternative aspects of the inventive subject matter, ammonia production can also be performed in a decentralized and relatively small-scale manner. Most typically, small scale production include chemical reactions or electrolysis of electrolytes liberating NH₃ or NH₄⁺, which may be performed under pressure, or at ambient conditions. Transportation then is contemplated for the precursors, reactants, and/or electrolytes to the decentralized ammonia production points (e.g., home or public or private facility).

In preferred aspects of the inventive subject matter, the ammonia is delivered to the fueling station by truck or pipeline, and stored at suitable conditions (most typically in one or more underground storage tanks. Ammonia is then withdrawn from the storage tank/tanks in continuous manner or on demand, and regasified where appropriate. Where desired, the pressure may be adjusted to facilitate downstream processing: For example, where the ammonia is stored at relatively low pressure, a pump may be used to increase pressure on the liquid ammonia, which allows for downstream processing of ammonia vapor or hydrogen gas without the need for gas compression. On the other hand, where the storage pressure is relatively high, the pressure may be reduced to generate power, which may be used for recompression of ammonia vapor or hydrogen gas.

Cracking of the stored and optionally regasified ammonia at the service station (or other location) is preferably accomplished by feeding vaporized ammonia to a catalytic reactor (typically operating at about 50 psig) that contains a cracking catalyst (e.g., nickel oxide catalyst and ruthenium salt promoter). There are numerous ammonia cracking reactors known in the art, and all of them are deemed suitable for use herein. Most preferably, the ammonia converter is similar to a Lewis Reactor as described in U.S. Pat. No. 4,666,680, incorporated by reference herein, which effectively utilizes the energy in the reactor effluent to supply a major portion of the endothermic heat with a minor supplemental heat supplied using the PSA offgas as a fuel. In other examples, suitable catalytic reactors and systems include autothermal reactors (e.g., U.S. Pat. App. 2005/0037244), reactors operating with Zr-based alloys (see e.g., WO 98/040311 or U.S. Pat. No. 5,976,723), reactors operating with ruthenium catalysts (see e.g. U.S. Pat. No. 5,055,282), and reactors operating with alumina with coated with various catalytic metals such as ruthenium, platinum, nickel, etc. (see e.g., U.S. Pat. No. 6,936,363 or 2,601,221).

The hot reactor effluent (typically at about at 500-800° C.) is recycled to the reactor via tubes contacting the catalyst to supply the endothermic heat required for the ammonia cracking. Additional heat from the effluent may be used to regasify the ammonia upstream of the catalytic reactor. The so (and optionally further cooled) effluent is then fed to an optional polishing unit in which undissociated ammonia is removed from the hydrogen and nitrogen gas. Most typically, such units will employ a cryogenic unit in which undissociated ammonia is liquefied at relatively moderate refrigeration requirements. For example, at least part of the refrigeration may be derived from the liquefied ammonia entering the regasification process. Alternatively, numerous other processes, including adsorption on molecular sieves or other solid phases, washing with solutions (e.g., acid aqueous) to dissolve or react the ammonia, and/or membrane separation may be suitable. There are numerous processes known in the art to separate ammonia from hydrogen and nitrogen, and all of them are deemed suitable for use herein. Regardless of the manner of separating undissociated ammonia, it is generally preferred that the ammonia is recycled back to the storage tank, which may require additional compression or pumping.

In further preferred aspects, a separation unit (e.g., a hydrogen-selective membrane, or pressure swing adsorption unit) may then receive the nitrogen/hydrogen gas mixture to reject the nitrogen into the atmosphere and purify the hydrogen to at least 80 mol %, preferably at least 90 mol %, and even more preferably at least 95 mol %. So produced H₂ may then be further compressed and stored at elevated pressure. Alternatively, and especially where the separation unit comprises a membrane unit, compression may also be effected upstream of the separation unit. Where desirable, the separation offgas (typically stored in a separate tank) can be used as fuel in the ammonia cracker for trim heat supply with no noticeable emissions.

It should further be appreciated that ammonia cracking configurations contemplated herein will preferably be based on anticipated hydrogen demand, which may be buffered with storage capacity of between 1 and 7 days (e.g., to accommodate for downtime due to service or other situation) to reduce overall hydrogen storage requirements. For example, ammonia cracking may be performed in a plurality of on-demand cycles wherein the so produced hydrogen is stored in a storage tank. The cycle frequency is preferably chosen such that higher production is in advance of anticipated demand. Such cycling may be espcially advantageous where a pressure swing adsorption unit is the hydrogen-nitrogen separator. Alternatively, cracking may also be continuously (in few instances at variable rates to accommodate fluctuations in demand) wherein the so produced hydrogen is stored in a storage tank. Regardless of the manner of hydrogen production, it is generally preferred that the stored hydrogen has a volume of less than 500%, more preferably less than 100%, and most preferably less than 50% of an average daily dispensed volume to reduce losses associated with storage.

Depending on the particular hydrogen delivery and fueling technology, it should be appreciated that the so produced hydrogen may be compressed, and optionally liquefied, or otherwise prepared for storage, which may also include storage in hydrogen tank modules that can be swapped with depleted modules from a car. Therefore, hydrogen storage may be in relatively large compressed tanks, in modules comprising a medium having relatively high hydrogen affinity (e.g., metal hydride alloys, metal-coated carbon nanostructures, etc.), and other suitable formats. Consequently, hydrogen storage may be at a relatively low pressure (e.g., between 1-5 bar, or higher pressure, between 5-50 bar or even higher).

Thus, specific embodiments and applications of configurations and methods of hydrogen fueling have been disclosed. It should be apparent, however, to those skilled in the art that many more modifications besides those already described are possible without departing from the inventive concepts herein. The inventive subject matter, therefore, is not to be restricted except in the spirit of the present disclosure. Moreover, in interpreting the specification and contemplated claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of providing hydrogen to an automobile at a fueling station, comprising:
receiving liquefied ammonia at an automobile fueling station from a remote ammonia source, and storing the liquefied ammonia in a storage tank;
converting at least part of the ammonia to hydrogen at the automobile fueling station, and optionally removing undissociated ammonia; and
providing the hydrogen to the automobile.

2. The method of claim 1 wherein the step of removing the undissociated ammonia comprises at least one of a cryogenic process, an adsorptive process, and a membrane separation.

3. The method of claim 2 wherein the removed ammonia is recycled.

4. The method of claim 1 further comprising a step of separating the hydrogen from nitrogen obtained in the step of converting.

5. The method of claim 1 wherein the step of converting the ammonia is performed in a plurality of on-demand cycles, and wherein the hydrogen is stored in a storage tank.

6. The method of claim 1 wherein the step of converting the ammonia is performed in a continuous mode, and wherein the hydrogen is stored in a storage tank.

7. The method of any one of claim 1 further comprising a step of compressing the hydrogen to at least fueling pressure.

8. The method of claim 5 or claim 6 wherein the stored hydrogen has a volume of less than 100% of an average daily dispensed volume.

9. The method of claim 5 or claim 6 wherein the stored hydrogen has a volume of less than 50% of an average daily dispensed volume.

10. The method of claim 1 wherein the ammonia is cracked in a catalytic process.

11. The method of claim 10 wherein the catalytic process is autothermal.

12. The method of claim 10 wherein the catalytic process employs a catalyst comprising at least one of nickel, ruthenium, and platinum.

13. The method of claim 1 wherein the liquefied ammonia has at least one of a pressure of at least 20 atm and a temperature of less than −35° C.

14. The method of claim 1 wherein the remote ammonia source is a gasification plant that optionally coproduces carbon dioxide for sequestration or enhanced oil recovery or for sale as a byproduct.

15. The method of claim 1 wherein the fueling station and the remote source are at least 10 miles apart.

16. An automobile fueling station comprising:
an ammonia storage tank configured to store liquid ammonia;
an ammonia cracking reactor fluidly coupled to the storage tank and configured to produce hydrogen from the ammonia;
a polishing unit fluidly coupled to the reactor and configured to remove undissociated ammonia;
a hydrogen storage tank and compressor fluidly coupled to the polishing unit and configured to provide compressed hydrogen; and
a filling dock that is fluidly coupled to the storage tank, wherein the filling dock is configured to provide compressed hydrogen to an automobile.

17. The fueling station of claim 16 wherein the polishing unit comprises at least one of a cryogenic unit, an adsorptive unit, and a membrane unit.

18. The fueling station of claim 16 further comprising a recycling conduit that provides the undissociated ammonia to the ammonia storage tank.

19. The fueling station of claim 16 wherein the ammonia cracking reactor comprises a catalytic autothermal reactor that is configured for continuous operation.

20. The fueling station of claim 16 further comprising a separation unit that is fluidly coupled to the ammonia cracking reactor and that is configured to separate hydrogen from nitrogen.
